(19) United States
(12) Patent Application Publication
(10) Pub. No.: US 2025/0329760 A1
(43) Pub. Date: Oct. 23, 2025

(54) FUEL CELL SYSTEM AND METHOD FOR STARTING A FUEL CELL SYSTEM

(71) Applicant: Robert Bosch GmbH, Stuttgart (DE)

(72) Inventors: Tobias Falkenau, Esslingen (DE); Gregory Rewers, Schwieberdingen (DE); Simon Buehler, Stuttgart (DE)

(21) Appl. No.: 18/868,920

(22) PCT Filed: May 24, 2023
(86) PCT No.: PCT/EP2023/063932

§ 371 Date: Nov. 25, 2024

(30) Foreign Application Priority Data
Jun. 2, 2022 (DE) 10 2022 205 645.0

(51) Int. Cl. H01M 8/04746; H01M 8/04223; H01M 8/04225; H01M 8/0438

(52) U.S. Cl. CPC H01M 8/04753; H01M 8/04225; H01M 8/04231; H01M 8/04388; H01M 8/04395; H01M 8/04432

(57) ABSTRACT

A method for starting a fuel cell system comprising: determining a first pressure difference between a first pressure, which is present in an anode chamber of the fuel cell system, the anode chamber being connected to an anode of at least one fuel cell, and an ambient pressure; determining a second pressure difference between a second pressure, which is present in a cathode chamber of the fuel cell system, the cathode chamber being connected to a cathode of the at least one fuel cell, and the ambient pressure; comparing the first pressure difference to a first threshold value; comparing the second pressure difference to a second threshold value; performing a pressure equalization between the anode chamber and the cathode chamber if the first pressure difference exceeds the ambient pressure by more than the first threshold value and/or if the second pressure difference exceeds the ambient pressure by more than the second threshold value; and feeding fuel into the anode chamber.

### BACKGROUND

The present invention relates to a fuel call system and a method for starting or powering up a fuel cell system.

Fuel cells are being increasingly used as energy converters, among other things in vehicles, in order to directly convert the chemical energy contained in a fuel, e.g., hydrogen together with oxygen, into electrical energy. Fuel cells comprises an anode, a cathode and an electrolytic membrane arranged between the anode and cathode. Oxidation of the fuel occurs at the anode, and a reduction of oxygen occurs at the cathode.

Oxygen is usually supplied to the cathode of a fuel cell by feeding ambient air into a flow chamber connected to the cathode. Ambient air is known to contain nitrogen. In particular, when the fuel cell is out of operation or at a standstill, i.e. when no reactants are supplied to the anode and cathode and the cell does not provide any electrical voltage, nitrogen may diffuse through the electrolyte membrane into an anode chamber connected to the anode. The nitrogen acts as an inert gas at the anode and in particular reduces the surface area of the anode, which is available for reaction with fuel. When starting operation of the fuel cell, the anode side is therefore typically first flushed with fuel in order to set a suitable concentration of fuel gas at the anode. This slows down the starting process of the fuel cell.

When operation of the fuel cell is stopped, the anode chamber is usually separated from the fuel supply by a valve and the cathode chamber is separated from the environment by shut-off valves. Therefore, it can happen that pressures deviating from the ambient pressure occur in the anode chamber and in the cathode chamber, particularly as a result of temperature changes. If the pressure on the anode side or the cathode side is above the ambient pressure, the rinsing process requires a considerable pressure build-up in the anode chamber. This can lead to a pressure difference between the anode side and the cathode side, which results in high mechanical stress on the electrolyte membrane.

EP 2 026 396 B1 discloses a fuel cell system wherein, in a shutdown procedure, the oxidant gas supply is interrupted and the cathode is isolated from the environment, while fuel continues to be supplied to the anode at a pressure that greater than or equal to ambient pressure and greater than or equal to the pressure on the cathode side, and current is drawn from the fuel cell by means of an electric load in order to consume the oxidizing gas at the cathode and to supply fuel to the cathode via the membrane. The aim of this procedure is to prevent oxidation gas from entering the cathode side during standstill.

### SUMMARY

Against this background, the present invention provides a method for starting a fuel cell system and a fuel cell system.

According to a first aspect of the invention, a method for starting a fuel cell system comprising: determining a first pressure difference between a first pressure, which is present in an anode chamber of the fuel cell system, the anode chamber being connected to an anode of at least one fuel cell, and an ambient pressure; determining a second pressure difference between a second pressure, which is present in a cathode chamber of the fuel cell system, the cathode chamber being connected to a cathode of the at least one fuel cell, and the ambient pressure; comparing the first pressure difference to a first threshold value; comparing the second pressure difference to a second threshold value, if the first pressure difference exceeds the ambient pressure by more than the first threshold value and/or if the second pressure difference exceeds the ambient pressure by more than the second threshold value, performing a pressure equalization between the anode chamber and the cathode chamber. In a further step, which is performed after pressure equalization if pressure equalization between the anode chamber and the cathode chamber is required, fuel is fed into the anode chamber and preferably oxidation gas is also fed into the cathode chamber.

According to a second aspect of the invention, a fuel cell system comprises at least one fuel cell having an anode, a cathode and an electrolyte membrane situated between the anode and the cathode, an anode chamber, which is fluidically connected to the anode of the at least one fuel cell, for passing gaseous fuel, having an inlet and an outlet, a fuel supply connected to the inlet of the anode chamber, fuel supply connected to the inlet of the anode chamber, a cathode chamber fluidically connected to the cathode of the at least one fuel cell for conducting oxidizing gas, having an inlet and an outlet, a first shut-off valve, via which the inlet of the cathode chamber can be connected to the environment, a second shut-off valve, via which the outlet of the cathode chamber can be connected to the environment, a purge valve, via which the anode chamber can be connected to the environment, a sensor system which is designed to detect a first pressure in the anode chamber, a second pressure in the cathode chamber and an ambient pressure, and a control device which is connected in a signal-conducting manner to the sensor system, the fuel supply, the purge valve and the first and/or second shut-off valve. The control device is configured to cause the fuel cell system to carry out the method according to the first aspect of the invention.

The features and advantages disclosed herein in connection with the method are thus also disclosed for the fuel cell system and vice versa.

One idea underlying the invention is to measure the pressure in the anode chamber and in the cathode chamber during start-up preparation, i.e. before electricity is produced with the fuel cell system, and to compare it with the ambient pressure. If one of the partial pressures deviates upwards from the ambient pressure by more than a limit value or threshold value, pressure equalization is carried out between the anode chamber and the cathode chamber. The pressures in the anode chamber and the cathode chamber are thus set to the same or essentially the same value before fuel is fed into the anode chamber to flush it.

One advantage of the invention is that, by equalizing the pressure when at least one of the partial pressures deviates from the ambient pressure by more than a threshold value or limit upwards, a pressure difference between the anode chamber and the cathode chamber that would place an excessive load on the electrolytic membrane is avoided when the fuel is supplied to flush the anode chamber. Furthermore, the pressure that is built up in the anode chamber for flushing by feeding in the fuel is reduced. This advantageously speeds up the starting process.

Advantageous embodiments and developments emerge from the further dependent claims and from the description with reference to the figures of the drawing.

According to some embodiments, it may be provided that the anode chamber and the cathode chamber are each fluidically connected to the environment in order to perform the pressure equalization between the anode chamber and the cathode chamber. Pressure equalization between the anode chamber and the cathode chamber is therefore achieved by setting ambient pressure in both chambers. This offers the advantage that pressures above the ambient pressure are avoided through pressure equalization. This further facilitates and accelerates the feeding of the fuel and additionally reduces the load on the membrane.

According to some embodiments, it may be provided that the anode chamber is connected directly to the environment by opening a flushing valve or to an inlet of the anode chamber, which is connected to the environment by opening at least one shut-off valve. The purge valve can, for example, establish a fluidic connection with an outlet section that connects the cathode chamber with the environment. The gas discharged from the anode chamber is conducted into the environment via the outlet section or the anode chamber assumes the pressure in the outlet section, which corresponds to the ambient pressure, by opening the purge valve. Alternatively, the purge valve can establish a fluidic connection with the inlet or a supply line of the cathode chamber, and the cathode chamber can be connected to the environment by at least one shut-off valve, so that the anode chamber assumes the pressure in the cathode chamber that corresponds to the ambient pressure after opening the respective shut-off valve by opening the flush valve.

According to some embodiments, it may be provided that the supply of fuel into the anode chamber is started when the anode chamber is fluidically connected to the environment, so that gas is flushed out of the anode chamber into the environment.

According to some embodiments, it may be provided that the fluidic connection of the anode chamber with the environment is disconnected after a predetermined period of time from the start of pressure equalization. This allows the pressure equalization to be controlled, for example. Alternatively, the fluidic connection between the anode chamber and the environment can be disconnected when the first pressure difference reaches a predetermined third threshold value. This means that pressure equalization can be regulated, for example. The third threshold value can, for example, correspond to the ambient pressure or a pressure slightly above the ambient pressure.

According to some embodiments, it may be provided that the first and second threshold values are each in a range between 10 mbar and 700 mbar. The threshold value essentially represents a maximum permissible deviation from the ambient pressure. Regardless of the specific value of the first and the second threshold values, the first and the second threshold values may be the same, for example.

According to some embodiments, it may be provided that the control device is configured to open the purge valve and at least one of the shut-off valves in order to perform the pressure equalization between the anode chamber and the cathode chamber, in order to fluidically connect the anode chamber and the cathode chamber to the environment.

According to some embodiments, it may be provided that the fuel supply comprises a fuel source and at least one fuel supply valve through which the fuel source is connectable to the anode chamber and which is connected to the control device in a signal-conducting manner, wherein the control device is configured to open the at least one fuel supply valve in order to supply gaseous fuel to the anode chamber.

### BRIEF DESCRIPTION OF THE DRAWINGS

The invention is explained below with reference to the figures of the drawings. The drawings show:

a schematic illustration of a hydraulic diagram of a fuel cell system FIG. 1 according to an exemplary embodiment of the invention; and

FIG. 2 the sequence of a process for starting a fuel cell system according to an exemplary embodiment of the invention.

### DETAILED DESCRIPTION

In the drawings, identical reference numerals denote identical or functionally identical components, unless stated otherwise.

FIG. 1 shows an example of a fuel cell system 100. As shown in FIG. 1, the fuel cell system 100 comprises at least one fuel cell 1, a fuel supply 4, a purge valve 6, an oxidizing gas supply 9, a first shut-off valve 51, a second shut-off valve 52, a sensor system 7 and a control device 8.

The fuel cell 1 is only shown schematically in FIG. 1 and comprises an anode 12, a cathode 14 and an electrolyte membrane 14 located between anode 12 and cathode 14. Gaseous fuel, such as hydrogen, is oxidized at the anode 12 and oxygen contained in an oxidizing gas, such as air, is reduced at the cathode 14. A proton exchange takes place between anode 12 and cathode 14 via the electrolyte membrane. The electrons emitted at the anode 12 during the chemical reaction are used to provide an electrical voltage.

For reasons of clarity, only one fuel cell 1 is shown schematically in FIG. 1. Of course, a plurality of fuel cells 1 can be provided, which are preferably arranged as a so-called stack and electrically connected in series. For the sake of simplicity, only one fuel cell 1 is referred to below. The explanations naturally also apply in the event that several fuel cells 1 are provided.

The anode 12 of the fuel cell 1 is fluidically connected to an anode chamber 12A, which is intended for the passage of gaseous fuel. If several fuel cells 1 are provided, they are all connected to the anode chamber 12A. The anode chamber 12A thus forms a kind of flow chamber in which the anode 12 is arranged. As shown schematically in FIG. 1, the anode chamber 12A has an inlet 15A, through which gaseous fuel can be supplied to the anode chamber 12A using the fuel supply 4, which is explained below, and an outlet 15B, through which unused fuel or gas in general can be discharged from the anode chamber 12A.

The cathode 14 of the fuel cell 1 is fluidically connected to a cathode chamber 14A, which is provided for the passage of oxidizing gas, such as air. If multiple fuel cells 1 are provided, all fuel cells 1 are connected to the cathode chamber 14A. The cathode chamber 14A thus forms a kind of flow chamber in which the cathode 14 is arranged. As shown schematically in FIG. 1, the cathode chamber 14A has an inlet 16A, through which gaseous fuel can be supplied to the cathode chamber 14A using the oxidizing gas supply 9, which is explained below, and an outlet 16B, through which gas and reaction products, in particular water, can be discharged from the cathode chamber 14A.

The fuel supply 4 is generally designed to supply gaseous fuel to the anode chamber 12A and thus to the anode 12. As shown in FIG. 1 as an example, the fuel supply 4 can in particular have a fuel source 41, e.g. in the form of a gas tank, and at least one supply valve 42, 43, through which the fuel source 41 can be connected to the anode chamber 12A. FIG. 1 shows an example of a fuel supply 4 with a recirculation system, which has a suction jet pump 44, a recirculation fan 45 and a fuel metering valve 43A, which forms a fuel supply valve 43. As shown schematically in FIG. 1, a pressure outlet of the suction jet pump 44 is connected to the anode inlet 15A, and a high-pressure inlet of the suction jet pump 44 is connected to the fuel source 41, wherein the fuel dosing valve 43A is arranged between the high-pressure inlet of the suction jet pump 44. A shut-off valve 42A, which also forms a fuel supply valve 42, can be arranged between the tank 41 and the fuel dosing valve 43A.

The recirculation fan 45 is arranged in a recirculation line 48, which connects the outlet 15B of the anode chamber 12A with a suction inlet of the suction jet pump 44. The recirculation fan 45 is configured to convey gas, in particular unused fuel, from the outlet 15B of the anode chamber 12A to the suction inlet of the suction jet pump 44.

As further shown in FIG. 1, a dehumidifier 46 can be arranged in the recirculation line 48 between the outlet 15B of the anode chamber 12A and the recirculation fan 45. The dehumidifier 46 is designed to remove water from the recirculated gas. Water accumulating in the dehumidifier 46 can, for example, be drained from the dehumidifier 46 via a drain valve 47.

The purge valve 6 can, for example, be arranged in a flush line 61 connected to the dehumidifier 46, as shown purely by way of example in FIG. 1. In general, the purging line 61 can be fluidically connected to the recirculation line 48 or to the outlet 15B of the anode chamber 12A. As shown in FIG. 1 as an example, the purging line 61 can also be connected to an outlet line 3 opening into the environment E. The purge valve 6 may, for example, be designed as a switchable valve, in particular as a solenoid valve, and may be switchable between an open state, in which it allows a flow of gas through the purge line 61, and a closed state, in which it closes the purge line 61. This means that the anode chamber 12A can be connected to the environment E through the purge valve 6.

The oxidizing gas supply 9 is generally designed to supply oxidizing gas, in particular air, to the cathode chamber 14A. As shown in FIG. 1 purely as an example, the oxidizing gas supply 9 can have a fan 91A for this purpose, which is arranged in a supply line 95 connected to the inlet 16A of the cathode chamber 14A and draws in air from the environment E. The outlet 16B of the cathode chamber 14A is connected to the outlet line 3 by a discharge line 96. As shown in FIG. 1, a recuperation turbine 91B may be arranged in one with the discharge line 96 to support a drive of the fan 91A.

As further shown as an example in FIG. 1, a humidifier 92 connected to the supply line 95 and the discharge line 96 can be provided, which is designed to remove water from the gas flowing in the discharge line 96 and to supply it to the oxidizing gas flowing in the supply line 95. The humidifier 92 can optionally be bypassed in the supply line 95 via a first bypass line 93, which can be shut off by a first bypass valve 93A.

As shown in FIG. 1, the first shut-off valve 51 can be arranged in the supply line 95, in particular between the fan 91A and the optional humidifier 92. The first shut-off valve 51 may, for example, be designed as a switchable valve, in particular as a solenoid valve, and may be switchable between an open state, in which it allows a flow of gas through the supply line 95, and a closed state, in which it closes the supply line 95. The cathode chamber 14A can thus be connected to the environment E through the first shut-off valve 51.

As shown in FIG. 1, the second shut-off valve 52 can be arranged in the discharge line 96, in particular between the outlet line 3 or the turbine 91B, if provided, and the optional humidifier 92. The second shut-off valve 52 can, for example, be designed as a non-return valve, which only permits a flow in the direction of environment E, as shown in FIG. 1 as an example. Alternatively, the second shut-off valve 52 can also be designed as a switchable valve, e.g. as a solenoid valve. The cathode chamber 14A can thus be connected to the environment E through the second shut-off valve 52.

As also shown in FIG. 1, a second bypass line 94 can optionally be provided, which connects the supply line 95 and the discharge line 96 and can be shut off by a second bypass valve 94A.

The sensor system 7 can have multiple pressure sensors 71, 72, 73. As shown schematically in FIG. 1, a first pressure sensor 71 may be provided at the anode chamber 12A to detect a first pressure prevailing in the anode chamber 12A. FIG. 1 shows, by way of example, that the first pressure sensor 71 detects the first pressure directly in the anode chamber 12A. Of course, the first pressure sensor 71 can also detect the first pressure in the recirculation line 48, for example between the outlet 15B of the anode chamber 12A and the dehumidifier 46, or between the suction jet pump 44 and the inlet 15A of the anode chamber 12A. Also, a plurality of pressure sensors may sense the pressure in the recirculation line 48, for example between the outlet 15B of the anode chamber 12A and the dehumidifier 46, and between the suction jet pump 44 and the inlet 15A of the anode chamber 12A and/or in the anode chamber 12A itself, wherein the first pressure is approximated by averaging the sensed pressures.

A second pressure sensor 72 may be provided at the cathode chamber 14A to detect a second pressure prevailing in the cathode chamber 14A. FIG. 1 shows an example of the second pressure sensor 71 detecting the first pressure directly in the cathode chamber 14A. Of course, the second pressure sensor 72 can also detect the second pressure in supply line 95, for example at inlet 16A of cathode chamber 14A, or in discharge line 96, for example at outlet 16B of cathode chamber 14A. Multiple pressure sensors can also detect the pressure at the inlet 16A, at the outlet 16B and/or in the anode chamber 12A itself, whereby an average value of the detected pressures is formed as the second pressure.

A third pressure sensor 73 detects the ambient pressure prevailing in the environment E.

In general, the sensor system 7 is thus designed to detect a first pressure in the anode chamber 12A, a second pressure in the cathode chamber 14A and an ambient pressure.

The control device 8 is only shown symbolically as a block in FIG. 1. The control device 8 is designed in particular as an electronic control device 8 and is thus set up to generate and output signal or control signals based on input signals. For example, the control device 8 can have a computing device, in particular a processor, such as a CPU, an FPGA, an ASIC or the like, and a data memory that can be read by the processor. In particular, the data memory can have a non-volatile data storage medium, e.g. in the form of a hard disk, a flash memory, an SD memory or the like, and store software which can be executed by the processor and causes the control device to output output signals.

The control device 8 is connected to the sensor system 7, the fuel supply 4, in particular the fuel supply valves 42, 43, the purge valve 6 and the first and/or the second shut-off valve 51, 52, in a signal-conducting manner, for example via a wired bus system or wirelessly via WiFi, Bluetooth or the like. In particular, the control device 8 is configured to switch the valves 42, 43, the purge valve 6, the first shut-off valve 51 and, if switchable, the second shut-off valve 52 of the fuel cell system 100. Similarly, the control device 8 may be connected to the drive of the fan 91A and the drive of the recirculation fan 45 to control the operation of these components. If present, the control device 8 may also be connected to the bypass valves 93A, 94A and the drain valve 47 and may be configured to switch these valves 93A, 94A, 47.

When the fuel cell system 100 is started, the anode chamber 12A is usually first purged with gaseous fuel in order to remove nitrogen or other undesirable substances that have collected in the anode chamber 12A during standstill. For this purpose, the control device 8 opens the purge valve 6 and the fuel supply valves 42, 43, so that fuel flows from the tank 41 into the anode chamber 12A and the gas contained therein is discharged from it into the environment E via the purge line 61. Depending on the pressure in the anode chamber 12A and in the cathode chamber 14A, this process can lead to considerable pressure differences between the anode chamber 12A and the cathode chamber 14A.

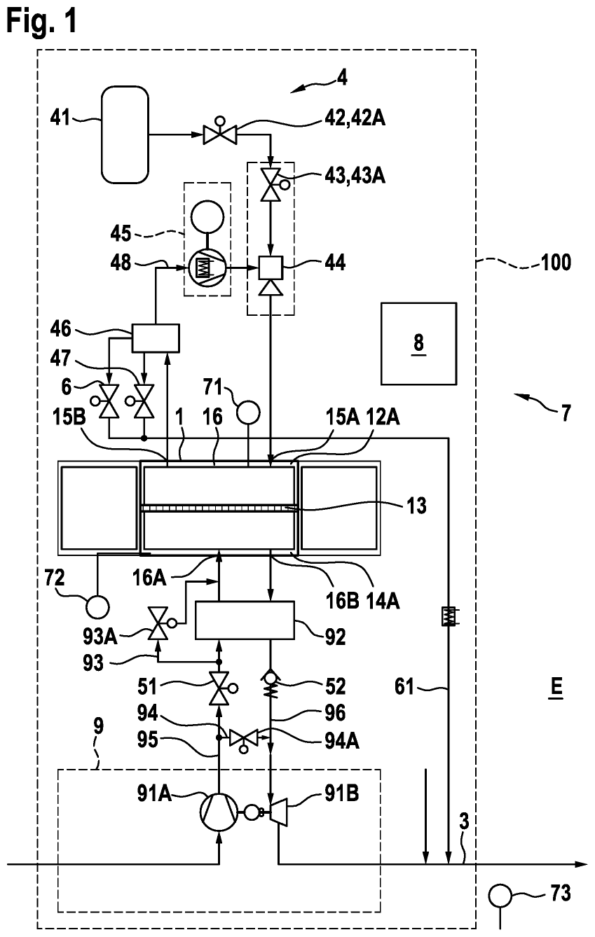

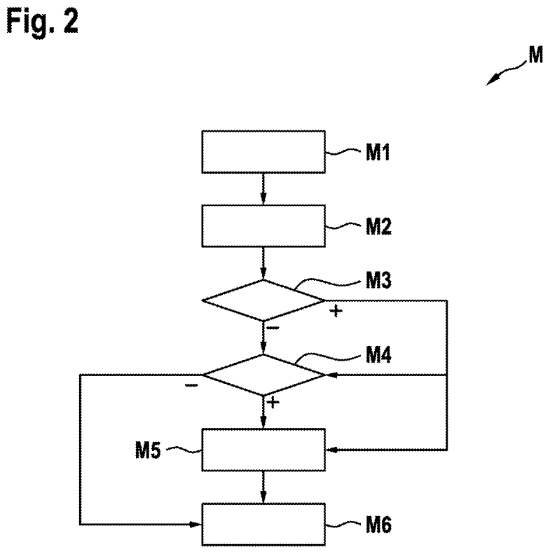

FIG. 2 shows an example of the sequence of a method M for starting a fuel cell system 100, which is explained below with reference to the fuel cell system 100 shown in FIG. 1.

In step M1, the control device 8 determines a first pressure difference between the first pressure that is present in the anode chamber 12A of the fuel cell system 100 and an ambient pressure. For this purpose, the control device 8 uses, for example, the first pressure recorded by the first pressure sensor 71 and the ambient pressure recorded by the third pressure sensor 73.

In step M2, the control device 8 determines a second pressure difference between the second pressure that is present in the cathode chamber 14A of the fuel cell system 100 and the ambient pressure. For this purpose, the control device 8 uses, for example, the second pressure recorded by the first pressure sensor 72 and the ambient pressure recorded by the third pressure sensor 73.

In step M3, the control device 8 compares the determined first pressure difference with a first threshold value for the first pressure. If the first pressure difference is higher than the ambient pressure by more than the first threshold value, as shown in FIG. 2 by the symbol “+”, the procedure M can either go directly to step M5 or first to step M4. If the first pressure difference is higher than the ambient pressure by less than or exactly by the first threshold value, as shown in FIG. 2 by the symbol “−”, the method M proceeds to step M4.

Step M4 is a further comparison step in which the control device 8 performs a comparison between the second pressure difference and a second threshold value. The second threshold value can be the same as the first threshold value or can be a different value. In general, the first and second threshold values can each lie in a range between 10 mbar and 700 mbar.

If it is determined in step M4 that the second pressure difference is higher than the ambient pressure by more than the second threshold value, as shown in FIG. 2 by the “+” symbol, the procedure M proceeds to step M5. If it is determined in step M4 that the second pressure difference is higher than the ambient pressure by less than or exactly by the second threshold value, as shown in FIG. 2 by the symbol “−”, the method M proceeds to step M6. As already explained above and as can also be seen in FIG. 2, step M5 can also be carried out independently of the comparison result from step M4. Step M5 is thus performed if the first pressure difference is higher than the ambient pressure by more than the first threshold value and/or if the second pressure difference is higher than the ambient pressure by more than the second threshold value.

In step M5, pressure equalization is performed between the anode chamber 12A and the cathode chamber 14A. For example, the anode chamber 12A and the cathode chamber 14A can each be fluidically connected to the environment E. In particular, the control device 8 can switch the purge valve 6 and at least one of the shut-off valves 51, 52, e.g. the first shut-off valve 51 in FIG. 1, to an open state. The anode chamber 12A is thus connected to the environment E via the purge line 61 and the outlet line 3, the cathode chamber 14A via the inlet line 95. In this way, ambient pressure or at least near-ambient pressure is set relatively quickly in both the anode chamber 12A and the cathode chamber 14A. The fluidic connection of the anode chamber 12A with the environment E can be disconnected again after a predetermined period of time from the start of pressure equalization, e.g. by the control device 8 closing the purge valve 6 and the at least one open shut-off valve 51, 52 again after the time has elapsed. Alternatively, the control device 8 can continuously determine at least the first pressure difference and, when this reaches a predetermined third threshold value, switch the purge valve 6 and the at least one open shut-off valve 51, 52 back to the closed state.

In step M6, fuel is fed into the anode chamber 12A in order to flush it. For this purpose, the control device 8 can, for example, switch the at least one fuel supply valve 42, 43 such that a fluidic connection is established between the fuel source and the anode chamber 12A. A flow rate or a pressure generated by the fuel in the anode chamber 12A can be controlled or regulated, for example, via an opening degree of the metering valve 43A. If pressure equalization is carried out in step M5, step M6 is only performed after pressure equalization. Optionally, the supply M6 of fuel into the anode chamber 12A can be started by the control device 8 if the anode chamber 12A is fluidically connected to the environment E, so that gas is purged out of the anode chamber 12A into the environment E.

Although the present invention has been explained hereinabove by way of example with reference to exemplary embodiments, it is not limited thereto and can be modified in many ways. Combinations of the above exemplary embodiments are in particular also conceivable.

In particular, the fuel cell system 100 is not limited exactly to the hydraulic circuit shown in FIG. 1. For example, the purging line 61 can also be connected to the inlet 16A of the cathode chamber 14A. In this way, the anode chamber 12A can also be connected to the environment E via a switchable second shut-off valve 52 through the purging line 61, the discharge line 96 and the drain line 3. The anode chamber 12 can thus generally be connected to the cathode chamber 14A or directly to the environment E via the purge valve 6.

1. A method (M) for starting a fuel cell system (200), comprising:
determining (M1) a first pressure difference between a first pressure, which is present in an anode chamber (12A) of the fuel cell system (100), the anode chamber (12A) being connected to an anode (12) of at least one fuel cell (1), and an ambient pressure;
determining (M2) a second pressure difference between a second pressure, which is present in a cathode chamber (14A) of the fuel cell system (100), the cathode chamber (14A) being connected to a cathode (14) of the at least one fuel cell (1), and the ambient pressure;
comparing (M3) the first pressure difference to a first threshold value;
comparing (M4) the second pressure difference to a second threshold value;
performing (M5) a pressure equalization between the anode chamber (12A) and the cathode chamber (14A) if the first pressure difference exceeds the ambient pressure by more than the first threshold value and/or if the second pressure difference exceeds the ambient pressure by more than the second threshold value; and
feeding (M6) fuel into the anode chamber (12A).

2. The method (M) according to claim 1, wherein, for performing (M5) the pressure equalization between the anode chamber (12A) and the cathode chamber (14A), the anode chamber (12A) and the cathode chamber (14A) are each fluidically connected to the environment (E)

3. The method (M) according to claim 2, wherein the anode chamber (12A) is connected directly to the environment (E) by opening a purge valve (6) or to an inlet (16A) of the anode chamber (14A), which is connected to the environment (E) by opening at least one shut-off valve.

4. The method (M) according to claim 2, wherein the supply (M6) of fuel to the anode chamber (12A) is started when the anode chamber (12A) is fluidically connected to the environment (E), such that gas is purged out of the anode chamber (12A) into the environment (E).

5. The method (M) according to claim 2, wherein the fluidic connection of the anode chamber (12A) to the environment (E) is disconnected after a predetermined period of time has elapsed from the start of the pressure equalization, or when the first pressure difference reaches a predetermined third threshold value.

6. The method (M) according to claim 1, wherein the first and second threshold values each lie in a range between 10 mbar and 700 mbar.

7. A fuel cell system (100), comprising:
at least one fuel cell (1) having an anode (12), a cathode (14), and an electrolyte membrane (14) located between the anode (12) and the cathode (3);
an anode chamber (12A) fluidically connected to the anode (12) of the at least one fuel cell (12) for the passage of gaseous fuel with an inlet (15A) and an outlet (15B);
a fuel supply (4) connected to the inlet (15A) of the anode chamber (12A);
a cathode chamber (14A) fluidically connected to the cathode (14) of the at least one fuel cell (12) for passing through oxidizing gas with an inlet (16A) and an outlet (16B);
a first shut-off valve (51), via which the inlet (16A) of the cathode chamber (14A) can be connected to the environment (E);
a second shut-off valve (52), via which the outlet (16B) of the cathode chamber (14A) can be connected to the environment (E);
a purge valve (6), via which the anode chamber (12A) can be connected to the environment (E)
a sensor system (7) which is designed to detect a first pressure in the anode chamber (12A), a second pressure in the cathode chamber (14A) and an ambient pressure; and
a control device (8) which is connected in a signal-conducting manner to the sensor system (7), the fuel supply (4), the purge valve (6) and the first and/or the second shut-off valve (51, 52) and is configured to cause the fuel cell system (100) to:
determine (M1) a first pressure difference between a first pressure, which is present in an anode chamber (12A) of the fuel cell system (100), the anode chamber (12A) being connected to an anode (12) of at least one fuel cell (1), and an ambient pressure;
determine (M2) a second pressure difference between a second pressure, which is present in a cathode chamber (14A) of the fuel cell system (100), the cathode chamber (14A) being connected to a cathode (14) of the at least one fuel cell (1), and the ambient pressure;
compare (M3) the first pressure difference to a first threshold value;
compare (M4) the second pressure difference to a second threshold value;
perform (M5) a pressure equalization between the anode chamber (12A) and the cathode chamber (14A) if the first pressure difference exceeds the ambient pressure by more than the first threshold value and/or if the second pressure difference exceeds the ambient pressure by more than the second threshold value; and
feed (M6) fuel into the anode chamber (12A).

8. The fuel cell system (100) according to claim 7, wherein the control device (8) is configured to execute (M5) the pressure equalization between the anode chamber (12A) and the cathode chamber (14A) by opening the purge valve (6) and at least one of the shut-off valves (51, 52) in order to fluidically connect the anode chamber (12A) and the cathode chamber (14A) to the environment (E).

9. The fuel cell system (100) according to claim 7, wherein the fuel supply (4) has a fuel source (41) and at least one fuel supply valve (42, 43), by means of which the fuel source (41) can be connected to the anode chamber (12A) and which is connected in a signal-conducting manner to the control device (8), wherein the control device (8) is configured to open the at least one fuel supply valve (41, 42) in order to supply gaseous fuel to the anode chamber (12A).
